(19) United States
(12) Patent Application Publication
(10) Pub. No.: US 2026/0241692 A1
(43) Pub. Date: Aug. 20, 2026

(54) LIQUID SUPPLY APPARATUS AND LIQUID EJECTION APPARATUS

(71) Applicant: SEIKO EPSON CORPORATION, Tokyo (JP)

(72) Inventors: Makoto SAWADAISHI, SHIOJIRI-SHI (JP); Yota TERAKAWA, SHIOJIRI-SHI (JP)

(21) Appl. No.: 19/539,412

(22) Filed: Feb. 13, 2026

(30) Foreign Application Priority Data
Feb. 17, 2025 (JP) 2025-023483

(51) Int. Cl. B41J 2/165; B41J 2/045; B41J 2/14

(52) U.S. Cl. CPC B41J 2/16526; B41J 2/04581; B41J 2/14; B41J 2/14233; B41J 2/1433; B41J 2/16508

(57) ABSTRACT

A liquid supply apparatus configured to be coupled to a liquid ejection head configured to eject a liquid from a nozzle includes: a supply flow path configured to supply the liquid from a liquid container configured to store the liquid to the liquid ejection head; a bubble trap chamber disposed in the supply flow path and configured to store a bubble in the supply flow path; a bubble discharge flow path coupled to the bubble trap chamber and configured to discharge the bubble in the bubble trap chamber; and a valve unit disposed in the bubble discharge flow path, in which the valve unit includes a valve body configured to open and close the bubble discharge flow path, and an adjustment section configured to adjust opening pressure at which the valve body opens the bubble discharge flow path.

The present application is based on, and claims priority from JP Application Serial Number 2025-023483, filed February 17, 2025, the disclosure of which is hereby incorporated by reference herein in its entirety.

### BACKGROUND

### 1. Technical Field

The present disclosure relates to a liquid supply apparatus and a liquid ejection apparatus including the liquid supply apparatus.

### 2. Related Art

For example, as in JP-A-2006-159482, there is an inkjet recording apparatus which is an example of a liquid ejecting apparatus including a recording head as an example of a liquid ejection head and an ink supply system as an example of a liquid supply apparatus. The inkjet recording apparatus supplies a liquid from an ink tank as an example of a liquid container to the recording head via an ink flow path as an example of a supply flow path. The inkjet recording apparatus includes a bubble collection chamber as an example of a bubble trap chamber, and a bubble discharge section.

The bubble collection chamber is installed in the ink flow path. In the bubble collection chamber, a ceiling hole is closed by a ball. The bubble discharge section discharges bubbles from the bubble collection chamber by opening the ceiling hole.

JP-A-2006-159482 is an example of the related art.

When controlling opening and closing with a valve, the bubbles can be discharged from the bubble trap chamber at any timing. However, for example, when the power of the apparatus is turned off in a state where the valve is open, the valve remains open, and therefore there is a concern that the liquid may leak.

### SUMMARY

A liquid supply apparatus which solves the problem described above is a liquid supply apparatus configured to be coupled to a liquid ejection head configured to eject a liquid from a nozzle, and including: a supply flow path configured to supply the liquid from a liquid container configured to store the liquid to the liquid ejection head; a bubble trap chamber disposed in the supply flow path and configured to store a bubble in the supply flow path; a bubble discharge flow path coupled to the bubble trap chamber and configured to discharge the bubble in the bubble trap chamber; and a valve unit disposed in the bubble discharge flow path, in which the valve unit includes a valve body configured to open and close the bubble discharge flow path, and an adjustment section configured to adjust opening pressure at which the valve body opens the bubble discharge flow path.

A liquid ejection apparatus which solves the problem described above includes: the liquid ejection head; and the liquid supply apparatus having the configuration described above.

### BRIEF DESCRIPTION OF THE DRAWINGS

FIG. 1 is a schematic diagram of an embodiment of a liquid ejection apparatus.

FIG. 2 is a schematic diagram of a valve unit in a discharge posture.

FIG. 3 is a schematic diagram of the valve unit in a standby posture.

### DESCRIPTION OF EMBODIMENTS

### Embodiment

An embodiment of a liquid ejection apparatus will hereinafter be described with reference to the drawings. The liquid ejection apparatus is an inkjet type printer that performs printing by ejecting ink as an example of a liquid onto a medium such as a paper sheet, a fabric, vinyl, a plastic component, or a metal component.

### Liquid Ejection Apparatus

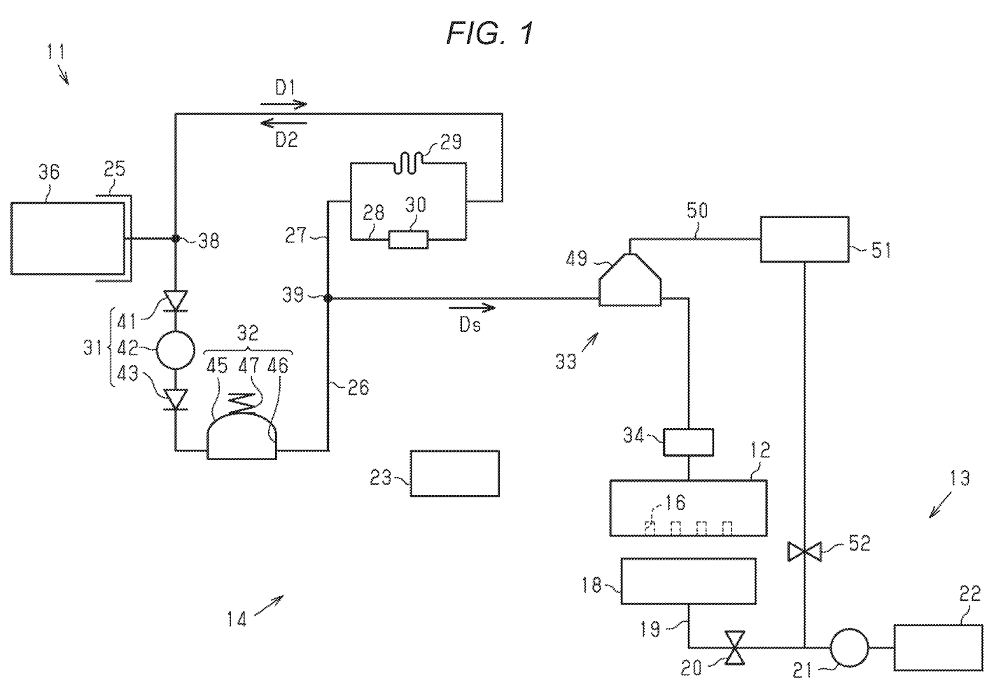

As shown in FIG. 1, a liquid ejection apparatus 11 may include a liquid ejection head 12, a maintenance mechanism 13, and a liquid supply apparatus 14.

The liquid ejection head 12 includes one or more nozzles 16. The liquid ejection head 12 can eject the liquid from the nozzles 16. The liquid ejection head 12 ejects the liquid from the nozzles 16 to perform printing on the medium (not shown).

### Maintenance Mechanism

The maintenance mechanism 13 may include a cap 18, a discharge flow path 19, a drain valve 20, and a suction unit 21. The discharge flow path 19 may be coupled to a waste liquid container 22. The waste liquid container 22 may be detachably attached to the liquid ejection apparatus 11.

The cap 18 can form a closed space in which the nozzles 16 are opened by coming into contact with the liquid ejection head 12. The cap 18 can receive the liquid discharged from the nozzles 16. The cap 18 may be provided to be movable to a capping position (not shown) and a separation position shown in FIG. 1.

The capping position is a position where the cap 18 is in contact with the liquid ejection head 12. The cap 18 located at the capping position forms the closed space by an opening of the cap 18 being closed by the liquid ejection head 12. The cap 18 located at the capping position caps the liquid ejection head 12.

The separation position is a position where the liquid ejection head 12 is opened. The cap 18 located at the separation position is separated from the liquid ejection head 12, and the opening of the cap 18 is opened. The cap 18 located at the separation position sets a space in the cap 18 as an open space.

The discharge flow path 19 has an upstream end coupled to the space in the cap 18 and a downstream end coupled to the waste liquid container 22. The discharge flow path 19 may be configured with, for example, a tube that is deformable following the movement of the cap 18. The discharge flow path 19 can discharge the liquid in the cap 18 to the waste liquid container 22.

The drain valve 20 is provided to the discharge flow path 19. The drain valve 20 can open and close the discharge flow path 19.

The suction unit 21 may be provided to the discharge flow path 19. The suction unit 21 is, for example, a tube pump. The suction unit 21 can depressurize the space in the cap 18 via the discharge flow path 19.

The maintenance mechanism 13 positions the cap 18 at the capping position and causes the suction unit 21 to depressurize the inside of the cap 18 in a state where the drain valve 20 is opened to thereby perform suction cleaning. The maintenance mechanism 13 discharges the liquid from the nozzles 16 by performing the suction cleaning.

### Liquid Supply Apparatus

The liquid supply apparatus 14 may include a controller 23. The controller 23 integrally controls driving of each mechanism in the liquid supply apparatus 14 and controls various operations executed in the liquid supply apparatus 14. The controller 23 may control various operations executed in the liquid ejection apparatus 11.

The controller 23 can be configured as a circuit including α: one or more processors that execute various kinds of processing in accordance with a computer program, β: one or more dedicated hardware circuits that execute at least some processing out of the various kinds of processing, or γ: a combination of α and β. The hardware circuit is, for example, an application specific integrated circuit. The processor includes a CPU and a memory such as a RAM and a ROM, and the memory stores program codes or commands configured to cause the CPU to execute the processing. The memory, that is, a computer-readable medium includes any readable medium that can be accessed by a general-purpose or dedicated computer.

The liquid supply apparatus 14 may include a mounting portion 25, a supply flow path 26, a branch flow path 27, and a parallel flow path 28. The liquid supply apparatus 14 may include a resistance flow path 29 and a regulator 30. The liquid supply apparatus 14 may include a liquid feeding section 31, a buffer 32, a deaeration section 33, and a pressure-regulating valve 34.

The liquid supply apparatus 14 can be coupled to the liquid ejection head 12. The liquid supply apparatus 14 supplies the liquid to the liquid ejection head 12 from a liquid container 36 mounted on the mounting portion 25. The liquid flows through the supply flow path 26 in a supply direction Ds.

The liquid container 36 may be detachably attached to the mounting portion 25. The liquid container 36 stores the liquid.

An upstream end of the supply flow path 26 in the supply direction Ds is coupled to the liquid container 36. The upstream end of the supply flow path 26 may be, for example, a hollow needle to be inserted into the liquid container 36. The upstream end of the supply flow path 26 may be provided to the mounting portion 25. By the supply flow path 26 being coupled to the liquid container 36 mounted on the mounting portion 25, the liquid stored in the liquid container 36 can be led out. A downstream end of the supply flow path 26 in the supply direction Ds is coupled to the liquid ejection head 12. The supply flow path 26 supplies the liquid from the liquid container 36 to the liquid ejection head 12.

The supply flow path 26 is provided with a first coupling portion 38 and a second coupling portion 39. The first coupling portion 38 is disposed upstream of the liquid feeding section 31. The first coupling portion 38 may be disposed between the upstream end of the supply flow path 26 and the liquid feeding section 31. The second coupling portion 39 is disposed downstream of the liquid feeding section 31. The second coupling portion 39 is disposed between the liquid feeding section 31 and the pressure-regulating valve 34. The second coupling portion 39 may be disposed between the buffer 32 and the deaeration section 33.

The branch flow path 27 branches from the supply flow path 26. The branch flow path 27 may be coupled to the first coupling portion 38 and the second coupling portion 39. That is, the branch flow path 27 may branch from the supply flow path 26 at the first coupling portion 38 and join the supply flow path 26 at the second coupling portion 39. The branch flow path 27 may branch from the supply flow path 26 at the second coupling portion 39 and join the supply flow path 26 at the first coupling portion 38.

The liquid can flow through the branch flow path 27 in a first branch direction D1 and a second branch direction D2 opposite to the first branch direction D1. The first branch direction D1 is a direction from the first coupling portion 38 toward the second coupling portion 39. The second branch direction D2 is a direction from the second coupling portion 39 toward the first coupling portion 38.

The resistance flow path 29 is provided to the branch flow path 27. The cross-sectional area of the resistance flow path 29 may be smaller than the cross-sectional area of the branch flow path 27. The resistance flow path 29 may be thinner than the branch flow path 27. The resistance flow path 29 may meander. The resistance flow path 29 increases resistance of the branch flow path 27. Specifically, the resistance of the branch flow path 27 is higher than the resistance of the supply flow path 26 between the liquid feeding section 31 and the pressure-regulating valve 34. The resistance of the branch flow path 27 is higher than the resistance of the supply flow path 26 between the second coupling portion 39 and the pressure-regulating valve 34. The resistance flow path 29 makes a flow rate of the liquid flowing through the branch flow path 27 lower than a flow rate of the liquid flowing through the supply flow path 26.

The parallel flow path 28 is disposed in parallel to the branch flow path 27. The parallel flow path 28 is coupled to both sides of the resistance flow path 29. Specifically, the parallel flow path 28 is coupled to the branch flow path 27 between the resistance flow path 29 and the first coupling portion 38 and the branch flow path 27 between the resistance flow path 29 and the second coupling portion 39.

The regulator 30 is disposed in the parallel flow path 28. The regulator 30 opens and closes the parallel flow path 28 in accordance with a difference in pressure between the parallel flow path 28 at the first coupling portion 38 side and the parallel flow path 28 at the second coupling portion 39 side. When the pressure difference is small, the regulator 30 closes the parallel flow path 28. When the pressure difference becomes larger than preset pressure, the regulator 30 opens the parallel flow path 28.

The liquid feeding section 31 is disposed in the supply flow path 26 upstream of the pressure-regulating valve 34. The liquid feeding section 31 may be disposed between the first coupling portion 38 and the buffer 32. The liquid feeding section 31 feeds the liquid in the supply direction Ds. The liquid feeding section 31 pressurizes the liquid to supply the liquid to the liquid ejection head 12. The liquid feeding section 31 may include a first one-way valve 41, a supply pump 42, and a second one-way valve 43.

The supply pump 42 is disposed between the first one-way valve 41 and the second one-way valve 43. The supply pump 42 is disposed in the supply flow path 26. The supply pump 42 is, for example, a diaphragm pump.

The first one-way valve 41 is disposed upstream of the supply pump 42. The second one-way valve 43 is disposed downstream of the supply pump 42. The first one-way valve 41 and the second one-way valve 43 allow the liquid to flow downstream in the supply direction Ds and restrict a flow of the liquid upstream.

The buffer 32 is disposed in the supply flow path 26 between the liquid feeding section 31 and the second coupling portion 39. The buffer 32 stabilizes the pressure of the liquid flowing through the supply flow path 26. The buffer 32 may include a flexible member 45, a storage chamber 46, and a supply spring 47.

The storage chamber 46 is disposed in the supply flow path 26. The storage chamber 46 stores the liquid. The flexible member 45 forms a part of a wall surface of the storage chamber 46. The flexible member 45 can flexurally be deformed. The flexible member 45 changes the volume of the storage chamber 46. The supply spring 47 pushes the flexible member 45 from the outside of the storage chamber 46. The supply spring 47 applies supply pressure to the liquid in the storage chamber 46.

The pressure-regulating valve 34 is disposed in the supply flow path 26 downstream of the deaeration section 33. The pressure-regulating valve 34 stabilizes the pressure of the liquid that is pressure-fed to the nozzles 16 by regulating the pressure of the liquid thus pressure-fed. The pressure-regulating valve 34 regulates the pressure of the liquid in the liquid ejection head 12 to pressure at which a meniscus is formed in the nozzle 16. The pressure-regulating valve 34 opens the supply flow path 26 when downstream pressure is lower than a predetermined pressure. For example, when the liquid is ejected from the nozzles 16 or the liquid is suctioned from the nozzles 16, the liquid in the liquid ejection head 12 decreases and the pressure of the liquid decreases. When the downstream negative pressure increases, the pressure-regulating valve 34 opens the supply flow path 26 to supply the liquid to the liquid ejection head 12.

### Deaeration Section

The deaeration section 33 may include a bubble trap chamber 49, a bubble discharge flow path 50, a valve unit 51, and an exhaust valve 52.

The bubble trap chamber 49 is disposed in the supply flow path 26. The bubble trap chamber 49 may be disposed between the second coupling portion 39 and the pressure-regulating valve 34. The bubble trap chamber 49 stores bubbles in the supply flow path 26. The bubble trap chamber 49 may collect the bubbles flowing together with the liquid in an upper portion of the bubble trap chamber 49.

The bubble discharge flow path 50 is coupled to the bubble trap chamber 49. The bubble discharge flow path 50 discharges the bubbles in the bubble trap chamber 49. The bubble discharge flow path 50 may couple the bubble trap chamber 49 and the discharge flow path 19 to each other.

The exhaust valve 52 is disposed in the bubble discharge flow path 50. The exhaust valve 52 may be disposed between the valve unit 51 and the discharge flow path 19. The exhaust valve 52 can open and close the bubble discharge flow path 50.

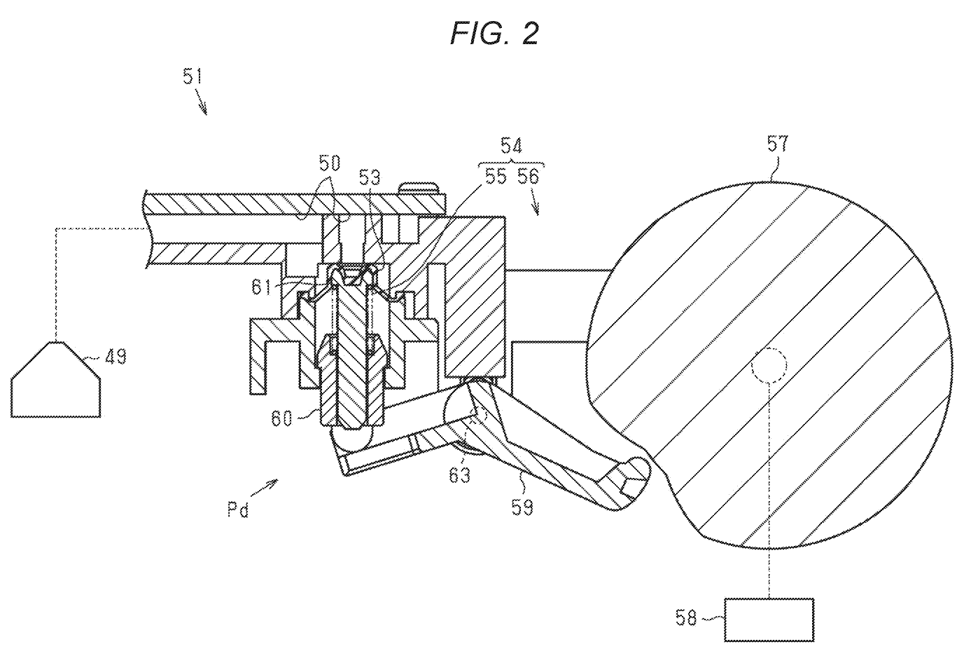

As illustrated in FIG. 2, the valve unit 51 is disposed in the bubble discharge flow path 50. The valve unit 51 includes a valve body 53 and an adjustment section 54.

The valve body 53 can open and close the bubble discharge flow path 50. The valve body 53 may close the bubble discharge flow path 50 by coming into contact with the wall surface of the bubble discharge flow path 50. The valve body 53 may open the bubble discharge flow path 50 by separating from the wall surface of the bubble discharge flow path 50.

The adjustment section 54 may include a pressure-regulating spring 55 and a cam section 56. The cam section 56 may include a cam plate 57, a driver 58, a lever 59, a spring seat 60, and a pressing portion 61.

The adjustment section 54 adjusts opening pressure at which the valve body 53 opens the bubble discharge flow path 50. Specifically, the pressure-regulating spring 55 applies the opening pressure to the valve body 53. The adjustment section 54 adjusts the opening pressure by changing force of the pressure-regulating spring 55 pressing the valve body 53.

The pressure-regulating spring 55 is disposed between the spring seat 60 and the pressing portion 61. The pressure-regulating spring 55 presses the pressing portion 61. The pressure-regulating spring 55 closes the bubble discharge flow path 50 by pressing the valve body 53 against the wall surface of the bubble discharge flow path 50 via the pressing portion 61.

The cam plate 57 is a non-circular plate. The driver 58 rotates the cam plate 57.

The lever 59 has a shaft 63. The lever 59 is swingable about the shaft 63. One end of the lever 59 makes contact with the cam plate 57. The lever 59 can swing by following the contour of the cam plate 57 that rotates. The other end of the lever 59 supports the spring seat 60. The lever 59 swings to reciprocate the spring seat 60.

The spring seat 60 supports the pressure-regulating spring 55. The spring seat 60 may movably support the pressing portion 61. The pressing portion 61 is movable in a pressing direction of the pressure-regulating spring 55.

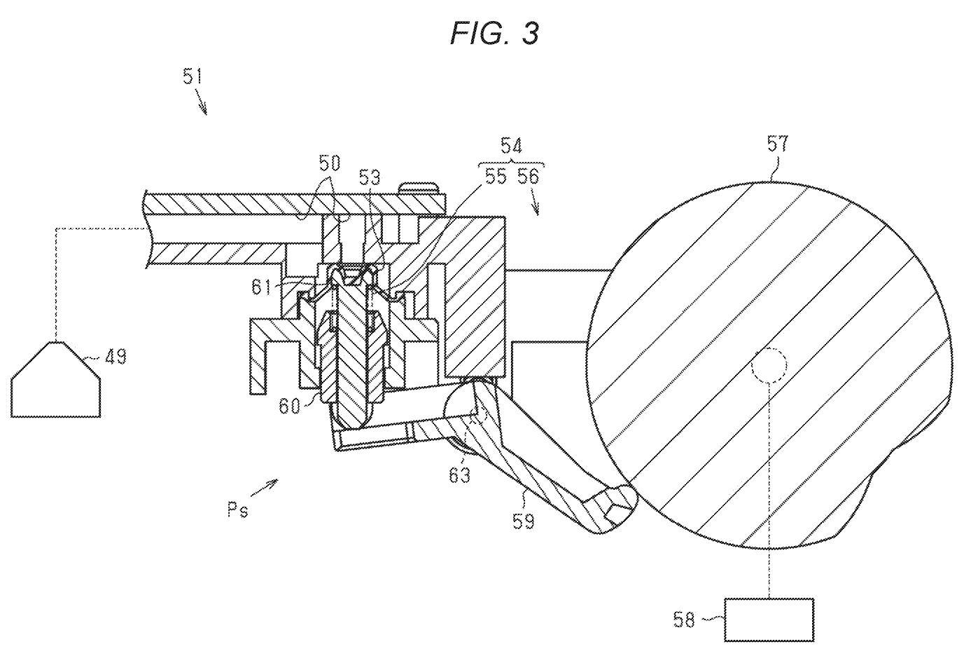

The cam section 56 changes the length of the pressure-regulating spring 55. The cam section 56 is displaceable between a discharge posture Pd shown in FIG. 2 and a standby posture Ps shown in FIG. 3. The discharge posture Pd is a posture taken at when performing the bubble discharge. The standby posture Ps is a posture taken during a standby period.

As shown in FIG. 2, in the cam section 56 in the discharge posture Pd, the spring seat 60 is located at a position away from the valve body 53. The cam section 56 in the discharge posture Pd causes the length of the pressure-regulating spring 55 to be longer than the length of the cam section 56 in the standby posture Ps. The cam section 56 in the discharge posture Pd may make the opening pressure at which the valve body 53 opens the bubble discharge flow path 50 smaller in magnitude than the pressure at which the liquid feeding section 31 pressurizes the liquid. In the cam section 56 in the discharge posture Pd, the opening pressure at which the valve body 53 opens the bubble discharge flow path 50 may be made smaller in magnitude than the supply pressure applied to the liquid by the buffer 32.

The posture of the cam section 56 is changed from the discharge posture Pd to the standby posture Ps by the driver 58 rotating the cam plate 57. Specifically, the lever 59 moves the spring seat 60 so as to be pushed up. The lever 59 contracts the pressure-regulating spring 55 by making the spring seat 60 closer to the valve body 53.

As illustrated in FIG. 3, the cam section 56 in the standby posture Ps may set the opening pressure at which the valve body 53 opens the bubble discharge flow path 50 to be larger in magnitude than the pressure at which the liquid feeding section 31 pressurizes the liquid. In the cam section 56 in the standby posture Ps, the opening pressure at which the valve body 53 opens the bubble discharge flow path 50 may be made larger in magnitude than the supply pressure applied to the liquid by the buffer 32.

### Functions of Present Embodiment

Functions of the present embodiment will be described.

As illustrated in FIG. 3, when printing is performed on the medium, the controller 23 sets the cam section 56 in the standby posture Ps.

As illustrated in FIG. 1, the controller 23 drives the liquid feeding section 31. The liquid feeding section 31 pressurizes the liquid located downstream of the liquid feeding section 31 by feeding the liquid in the supply direction Ds. When the liquid feeding section 31 is driven, the pressure in the first coupling portion 38 is lower than the pressure in the second coupling portion 39. The liquid in the supply flow path 26 flows into the branch flow path 27 from the second coupling portion 39. The liquid having flowed into the branch flow path 27 flows in the second branch direction D2 and flows out to the supply flow path 26 from the first coupling portion 38. However, the flow rate in the branch flow path 27 is suppressed by the resistance flow path 29. Therefore, the liquid is more likely supplied to the liquid ejection head 12 than to the branch flow path 27. The liquid is supplied to the liquid ejection head 12 in accordance with the ejection of the liquid. Since the cam section 56 is in the standby posture Ps, the bubble discharge flow path 50 is closed although the liquid feeding section 31 pressure-feeds the liquid.

When the liquid container 36 becomes empty during printing, the controller 23 stops driving the liquid feeding section 31. The controller 23 may notify a user to replace the liquid container 36. Even when the supply of the liquid by the liquid feeding section 31 is stopped, the buffer 32 supplies the liquid stored therein. That is, the supply spring 47 applies the supply pressure to the liquid in the storage chamber 46. Since the flow rate of the branch flow path 27 is suppressed, the liquid supplied from the buffer 32 is more likely supplied to the liquid ejection head 12 than to the branch flow path 27 similarly to when the liquid feeding section 31 is driven. By providing the buffer 32, it is possible to continue printing by an amount of the liquid stored therein even after the driving of the liquid feeding section 31 is stopped. Since the cam section 56 is in the standby posture Ps, the bubble discharge flow path 50 is closed although the buffer 32 pressure-feeds the liquid.

When the printing on the medium is completed, the controller 23 stops driving the liquid feeding section 31. When the bubbles in the bubble trap chamber 49 are discharged, the controller 23 sets the cam section 56 in the discharge posture Pd.

Specifically, the liquid feeding section 31 driving of which has stopped closes the supply flow path 26. Immediately after the driving of the liquid feeding section 31 is stopped, the pressure having been applied by the liquid feeding section 31 and the supply pressure by the supply spring 47 are applied to the liquid located between the liquid feeding section 31 and the pressure-regulating valve 34. Therefore, when the posture of the cam section 56 turns to the discharge posture Pd, the valve body 53 receives the supply pressure caused by the buffer 32 to open the bubble discharge flow path 50. The bubbles in the bubble trap chamber 49 are discharged so as to be pushed by the liquid thus pressurized.

The maintenance mechanism 13 may discharge the liquid that has entered the bubble discharge flow path 50. The controller 23 may move the liquid to the waste liquid container 22 by driving the suction unit 21 in a state where the drain valve 20 is closed and the exhaust valve 52 is opened.

### Advantages of Present Embodiment

Advantages of the present embodiment will be described.

(1-1) The adjustment section 54 adjusts the opening pressure. When the opening pressure is made larger in magnitude than the pressure in the supply flow path 26, the valve body 53 closes the bubble discharge flow path 50. That is, since the pressure in the supply flow path 26 is maintained, it is possible to stably supply the liquid to the liquid ejection head 12. When the opening pressure is made smaller in magnitude than the pressure in the supply flow path 26, the valve body 53 receives the pressure in the supply flow path 26 to open the bubble discharge flow path 50. Therefore, when the bubbles are discharged and the pressure in the supply flow path 26 decreases, the valve body 53 closes the bubble discharge flow path 50. Therefore, the possibility of liquid leakage can be reduced.

(1-2) The cam section 56 changes the length of the pressure-regulating spring 55. When the pressure-regulating spring 55 is deflected to be shortened, the elastic force thereof increases, and thus the opening pressure also increases. Therefore, the opening pressure can be adjusted with a simple configuration.

(1-3) The cam section 56 takes the standby posture Ps during standby periods and takes the discharge posture Pd during the bubble discharge. The cam section 56 is displaced from the standby posture Ps to the discharge posture Pd to thereby increase the length of the pressure-regulating spring 55. By lengthening the pressure-regulating spring 55 when discharging the bubbles, it is possible to make it easy to open the bubble discharge flow path 50.

(1-4) The buffer 32 is disposed in the supply flow path 26. Therefore, the supply pressure applied by the supply spring 47 also acts on the bubbles in the bubble trap chamber 49. When the cam section 56 takes the discharge posture Pd, the opening pressure becomes smaller in magnitude than the supply pressure, and thus the bubble discharge flow path 50 is opened by the supply pressure. The liquid supplied to the bubble trap chamber 49 when discharging the bubbles is the liquid stored in the storage chamber 46. Therefore, it is possible to stabilize the amount of bubbles and liquid to be discharged.

### Modified Examples

The present embodiment can be implemented with the following modifications. The present embodiment and the following modified examples can be implemented in combination with each other as long as no technical inconsistencies are involved.

In the cam section 56 in the discharge posture Pd, the opening pressure at which the valve body 53 opens the bubble discharge flow path 50 may be made larger in magnitude than the supply pressure applied to the liquid by the buffer 32 and smaller in magnitude than the pressure applied to the liquid by the liquid feeding section 31. The controller 23 may discharge the bubbles from the bubble trap chamber 49 by making the cam section 56 have the discharge posture Pd and driving the liquid feeding section 31.

The controller 23 may have a configuration not including the buffer 32.

When the time having elapsed from the previous bubble discharge is long, the controller 23 may drive the liquid feeding section 31 to discharge the bubbles. When the liquid ejection apparatus 11 is powered on, the controller 23 may drive the liquid feeding section 31 to discharge the bubbles.

The controller 23 may control the cam section 56 and the supply pump 42 when filling the supply flow path 26 with the liquid. The controller 23 may set the cam section 56 in the discharge posture Pd. The controller 23 may drive the supply pump 42 to fill the bubble trap chamber 49 with the liquid while discharging the air in the supply flow path 26 from the bubble discharge flow path 50. When filling the supply flow path 26 with the liquid, the cam section 56 is set to the discharge posture Pd. Therefore, when the supply pump 42 pressurizes the air in the supply flow path 26, the valve body 53 is pushed by the pressurized air to open the bubble discharge flow path 50. Therefore, the air can be easily removed from the bubble discharge flow path 50 compared to when the air in the supply flow path 26 is removed from, for example, the liquid ejection head 12.

The liquid supply apparatus 14 may include, for example, a solenoid that changes the position of the spring seat 60.

The liquid ejection apparatus 11 can be a liquid ejection apparatus that jets or ejects other liquids than ink. The state of the liquid to be ejected as a minute amount of droplet from the liquid ejection apparatus includes a particle state, a teardrop state, and a state of tailing like a thread. The liquid mentioned here may sufficiently be any material that can be ejected from the liquid ejection apparatus. For example, the liquid may be any substance in a liquid phase and includes a liquid material high or low in viscosity, sol, gel water, other inorganic solvents, organic solvents, solutions, and a fluid material such as liquid resin, liquid metal, and metal melt. The liquid includes not only a liquid as one state of a substance, but also a liquid obtained by dissolving, dispersing, or mixing particles of a functional material formed of a solid substance such as pigments or metal particles in a solvent. Representative examples of the liquid include such ink as described in the above embodiment and a liquid crystal. Here, the term ink includes various types of liquid compositions such as general water-based ink, oil-based ink, gel ink, and hot melt ink. Specific examples of the liquid ejection apparatus include an apparatus that ejects a liquid containing, in a dispersed or dissolved form, a material such as an electrode material or a coloring material used for manufacturing, for example, a liquid crystal display, an electroluminescence display, a surface-emitting display, and a color filter. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of transparent resin such as ultraviolet curable resin onto a substrate in order to form a minute hemispherical lens used for an optical communication element or the like, an optical lens, or the like. The liquid ejection apparatus may be an apparatus that ejects an etching liquid such as acid or alkali in order to etch a substrate or the like.

### Definitions

The expression "at least one" used in the present specification means "one or more" of desired options. For example, the expression "at least one" used in the present specification means "either one of alternatives" or "both of two alternatives" when the number of the alternatives is two. As another example, the expression "at least one" used in the present specification means "only one alternative", "a combination of any two alternatives", or "a combination of any three or more alternatives" when the number of alternatives is three or more.

### Appendices

Technical ideas understood from the embodiment and modified examples described above and the functions and advantages thereof will hereinafter be described.

[1] A liquid supply apparatus is a liquid supply apparatus configured to be coupled to a liquid ejection head configured to eject a liquid from a nozzle, and including: a supply flow path configured to supply the liquid from a liquid container configured to store the liquid to the liquid ejection head; a bubble trap chamber disposed in the supply flow path and configured to store a bubble in the supply flow path; a bubble discharge flow path coupled to the bubble trap chamber and configured to discharge the bubble in the bubble trap chamber; and a valve unit disposed in the bubble discharge flow path, in which the valve unit includes a valve body configured to open and close the bubble discharge flow path, and an adjustment section configured to adjust opening pressure at which the valve body opens the bubble discharge flow path.

According to this configuration, the adjustment section adjusts the opening pressure. When the opening pressure is made larger in magnitude than the pressure in the supply flow path, the valve body closes the bubble discharge flow path. That is, since the pressure in the supply flow path is maintained, the liquid can be stably supplied to the liquid ejection head. When the opening pressure is made smaller in magnitude than the pressure in the supply flow path, the valve body receives the pressure in the supply flow path to open the bubble discharge flow path. Therefore, when the bubbles are discharged and the pressure in the supply flow path decreases, the valve body closes the bubble discharge flow path. Therefore, the possibility of liquid leakage can be reduced.

[2] In the liquid supply apparatus according to [1] described above, the adjustment section may include a pressure-regulating spring configured to apply the opening pressure to the valve body, and a cam section configured to change a length of the pressure-regulating spring.

According to this configuration, the cam section changes the length of the pressure-regulating spring. When the pressure-regulating spring is deflected to be shortened, the elastic force thereof increases, and thus the opening pressure also increases. Therefore, the opening pressure can be adjusted with a simple configuration.

[3] In the liquid supply apparatus according to [2] described above, the cam section may be configured to be displaced between a standby posture taken during a standby period, and a discharge posture taken during bubble discharge, and the cam section may make the pressure-regulating spring longer in length in the discharge posture than in the standby posture.

According to this configuration, the cam section takes the standby posture during the standby period and takes the discharge posture during the bubble discharge. The cam section is displaced from the standby posture to the discharge posture to thereby increase the length of the pressure-regulating spring. By lengthening the pressure-regulating spring when discharging the bubbles, it is possible to make it easy to open the bubble discharge flow path.

[4] The liquid supply apparatus according to [3] described above may further include a buffer disposed in the supply flow path, in which the buffer may include a storage chamber configured to store the liquid, a flexible member configured to form a part of a wall surface of the storage chamber, and a supply spring configured to press the flexible member from an outside of the storage chamber to apply supply pressure to the liquid in the storage chamber, and the cam section in the discharge posture may make the opening pressure smaller in magnitude than the supply pressure.

According to this configuration, the buffer is disposed in the supply flow path. Therefore, the supply pressure applied by the supply spring also acts on the bubbles in the bubble trap chamber. When the cam section takes the discharge posture, the opening pressure becomes smaller in magnitude than the supply pressure, and thus the bubble discharge flow path is opened by the supply pressure. The liquid supplied to the bubble trap chamber when discharging the bubbles is the liquid stored in the storage chamber. Therefore, it is possible to stabilize the amount of bubbles and liquid to be discharged.

[5] The liquid supply apparatus according to [3] described above may further include: a supply pump disposed in the supply flow path; and a controller configured to control the cam section and the supply pump, in which the controller may set the cam section in the discharge posture when driving the supply pump to fill the supply flow path with the liquid.

According to this configuration, when filling the supply flow path with the liquid, the cam section is set to the discharge posture. Therefore, when the supply pump pressurizes the air in the supply flow path, the valve body is pushed by the pressurized air to open the bubble discharge flow path. Therefore, the air can be easily removed from the bubble discharge flow path compared to when the air in the supply flow path is removed from, for example, the liquid ejection head.

[6] A liquid ejection apparatus includes: the liquid ejection head; and the liquid supply apparatus according to any one of [1] to [5] described above.

According to this configuration, it is possible to achieve substantially the same advantages as those of the liquid supply apparatus described above.

What is claimed is:

1. A liquid supply apparatus configured to be coupled to a liquid ejection head configured to eject a liquid from a nozzle, the apparatus comprising:
a supply flow path configured to supply the liquid from a liquid container configured to store the liquid to the liquid ejection head;
a bubble trap chamber disposed in the supply flow path and configured to store a bubble in the supply flow path;
a bubble discharge flow path coupled to the bubble trap chamber and configured to discharge the bubble in the bubble trap chamber; and
a valve unit disposed in the bubble discharge flow path, wherein
the valve unit includes
a valve body configured to open and close the bubble discharge flow path, and
an adjustment section configured to adjust opening pressure at which the valve body opens the bubble discharge flow path.

2. The liquid supply apparatus according to claim 1, wherein
the adjustment section includes
a pressure-regulating spring configured to apply the opening pressure to the valve body, and
a cam section configured to change a length of the pressure-regulating spring.

3. The liquid supply apparatus according to claim 2, wherein
the cam section is configured to be displaced between a standby posture taken during a standby period, and a discharge posture taken during bubble discharge, and
the cam section makes the pressure-regulating spring longer in length in the discharge posture than in the standby posture.

4. The liquid supply apparatus according to claim 3, further comprising
a buffer disposed in the supply flow path, wherein
the buffer includes
a storage chamber configured to store the liquid,
a flexible member configured to form a part of a wall surface of the storage chamber, and
a supply spring configured to press the flexible member from an outside of the storage chamber to apply supply pressure to the liquid in the storage chamber, and
the cam section in the discharge posture makes the opening pressure smaller in magnitude than the supply pressure.

5. The liquid supply apparatus according to claim 3, further comprising:
a supply pump disposed in the supply flow path; and
a controller configured to control the cam section and the supply pump, wherein
the controller sets the cam section in the discharge posture when driving the supply pump to fill the supply flow path with the liquid.

6. A liquid ejection apparatus comprising:
the liquid ejection head; and
the liquid supply apparatus according to claim 1.
